(19) United States
(12) Patent Application Publication
(10) Pub. No.: US 2026/0170461 A1
(43) Pub. Date: Jun. 18, 2026

(54) AUTOMATIC DETECTION AND REPAIR OF INCORRECT SCOPES IN DEPENDENCIES

(71) Applicant: SAP SE, Walldorf (DE)

(72) Inventors: Wolfram Fischer, Berlin (DE); Serena Ponta, Mouans-Saetoux (FR); Antonino Sabetta, Mouans-Saetoux (FR)

(21) Appl. No.: 18/980,782

(22) Filed: Dec. 13, 2024

(51) Int. Cl. G06Q 10/10

(52) U.S. Cl. CPC G06Q 10/103

(57) ABSTRACT

A computer-implemented method includes finding, using a plugin, a set of reachable dependencies in a production environment. Using the plugin, a set of reachable dependencies in a test environment is found. Using the plugin, a set of candidate dependencies is found. Using the plugin, a determination is made that an empty set does not exist. Using the plugin and as incorrect dependencies, a set of incorrectly scoped dependencies is found. The found incorrect dependencies are reported.

### BACKGROUND

Nearly all current software is built and depends on 3rd-party dependencies, which can easily number in the hundreds or thousands. Each of these dependencies has a scope, which is usually declared when a dependency is added to a project's dependency manager. Sometimes dependencies are added with an incorrect scope, or, over the lifetime of a project, the scope of a dependency can change without adjustments to a dependency manager's configuration. Dependencies with an incorrect scope can have a negative impact on projects with respect to, for example, security, maintenance costs, startup time, deployment time, and used bandwidth.

### SUMMARY

The present disclosure describes automatic detection and repair of incorrect scopes in dependencies.

In an implementation, a computer-implemented method, comprises: finding, using a plugin, a set of reachable dependencies in a production environment; finding, using the plugin, a set of reachable dependencies in a test environment; finding, using the plugin, a set of candidate dependencies; determining, using the plugin, that an empty set does not exist; finding, using the plugin and as incorrect dependencies, a set of incorrectly scoped dependencies; and reporting the incorrect dependencies.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach can improve security by having a positive impact on an artifact/binary attack surface. Second, the described approach can reduce maintenance costs. It is a best practice to continuously scan for dependencies with known vulnerabilities in modern software development. Although all dependencies with a known vulnerability should be updated as soon as possible, vulnerable dependencies which are only executed in a sandboxed test environment usually do not need to be fixed with the highest urgency, whereas vulnerabilities which are part of the artifact/binary need to be fixed immediately or the vulnerability has to be mitigated in other ways (e.g., with firewalls and/or security policies). Reducing the scope of dependencies directly impacts maintenance. In some implementations, the described approach can be integrated with GITHUB and any continuous integration/continuous delivery (CI/CD) pipelines to ensure scopes for all dependencies are correct and minimal. Third, the describe approach can reduce deployment times and bandwidth usage. For deployments, artifacts/binaries need to be rolled-out to servers or clients. Smaller artifacts/binaries mean faster deployment and less bandwidth used. Use of the described approach will enable faster and less expensive rollouts of artifacts/binaries. Fourth, the described approach can reduce a danger of using incorrect code. In many situations, parts of software are only provided at runtime. The described approach can utilize static and dynamic reachability analysis of software to find a set of dependencies which are only reachable from testing entry points. The same principle can be utilized to find dependencies with the incorrect scope regarding ‘runtime,’ ‘provided,’ etc. scopes.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating an example of a method for automatic detection and repair of incorrect scopes in dependencies, according to an implementation of the present disclosure.

FIG. 2 is a box diagram of a high-level architecture of a system to automatically detect and repair incorrect scopes in dependencies, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes automatic detection and repair of incorrect scopes in dependencies and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Nearly all current software is built and depends on 3rd-party dependencies (e.g., libraries and frameworks). For example, a project might depend on a 3rd-party library A (e.g., a direct dependency), where the 3rd-party library A itself depends on libraries B and C (e.g., transitive dependencies).

Dependencies can easily number in the hundreds or thousands of direct and/or transitive dependencies. Therefore, it is practically impossible to download and install dependencies manually. Build tools are used in modern software development to automate this task.

Each of these dependencies has a scope, which is usually declared when a dependency is added to a project's dependency manager. Sometimes dependencies are added with an incorrect scope, or, over the lifetime of a project, the scope of a dependency can change without adjustments to a dependency manager's configuration. Dependencies with an incorrect scope can have a negative impact on projects with respect to, for example, security, maintenance costs, startup time, deployment time, and used bandwidth.

At a high-level, a described approach permits detection of and optional repair of incorrect scopes in direct and transitive dependencies of software projects. The approach utilizes static and dynamic code analysis to determine which dependencies are effectively used within a specific scope and uses this information to detect and report dependencies with a deviant scope declaration.

Build tools usually differentiate between different scopes for dependencies, at least between a “test” and a “compile” scope. For the purposes of this disclosure, the meaning of a scope is, that a dependency is available for a project at a certain time of project (development) life phase. For example, a dependency with a scope “test” is available during (automatic) testing of software, such as when running unit tests. A “compile” or default scope means that the dependency is available during testing, a compile phase (if applicable), and during runtime of the software.

Terms “test” and “compile” scope are used by the APACHE MAVEN JAVA build/dependency tool, but the concepts are used by all modern build/dependency tools, such as Node Package Manager (NPM) (Node.js) using terms “dependencies” and “devDependencies,” the PYTHON build/dependency tool POETRY organizes dependencies in so-called dependency groups, which use at least “test,” “dev,” and an implicit “main” group as scopes and conforms to the PYPROJECT.TOML standard.

Dependencies can have an incorrect scope, where, for the purposes of this disclosure, an incorrect scope means that the scope for a dependency is wider than it needs to be for the software to work properly. Similarly, a correct scope for a dependency is defined as having a smallest scope possible, which still allows the software to run without errors caused by an absence of this dependency. As examples:
Example 1: Dependency A is only needed while running the unit tests of the software. Therefore, the correct scope for dependency A is “test.”
Example 2: Dependency B is needed while running the unit tests of the software and for executing the software. Therefore, the correct scope for dependency B is “compile.”
Example 3: Dependency C is needed while running the unit tests of the software and has the scope “compile.” Because dependency C is only used while running the unit tests of the software, it has the incorrect scope. The correct scope for dependency Cis “test.” The “compile” scope is too broad.
Example 4: Dependency D is needed while running the unit tests of the software and for executing the software and has the scope “test.” Because dependency D is needed in the testing and execution phase of the software, the scope “test” is incorrect, the correct scope is “compile.” In this case, the build system will show an error or the software will simply crash during runtime.

There is an obvious asymmetry between Example 3 and Example 4: If the scope is too wide (Example 3), everything will work without errors to an observer, while if the scope is too narrow (Example 4), an observer will observe erroneous behavior. Automatically detecting dependencies with too wide of a scope (Example 3) is desirable, although detecting and reporting one too narrow of scopes (Example 4) is also advantageous.

A question can be asked as to why it desirable to detect scopes that are too wide, if to an observer this type of scope error allows the software to be tested and executed without observable errors. In some implementations, reasons can be to:

### Improve Security.

The dependency in Example 3 would end up in an artifact/binary, which will be executed for dynamic languages (e.g., JAVA, NODE.JS, PYTHON, RUBY), which means it significantly increases an attack surface for attackers (e.g., providing gadgets especially for easy remote code execution). For technology platforms (such as, SAP BUSINESS TECHNOLOGY PLATFORM and other micro service based platforms) the described approach can have a positive impact on the attack surface.

### Reduce Maintenance Costs.

It is a best practice to continuously scan for dependencies with known vulnerabilities in modern software development (e.g., using GITHUB and continuous integration/continuous delivery (CI/CD) pipelines to build software and automatic security scanners for dependencies). Although all dependencies with a known vulnerability should be updated as soon as possible, vulnerable dependencies which are only executed in a sandboxed test environment usually do not need to be fixed with the highest urgency, whereas vulnerabilities which are part of the artifact/binary need to be fixed immediately or the vulnerability has to be mitigated in other ways (e.g., with firewalls and/or security policies). Reducing a width of the scope of dependencies directly impacts maintenance. In some implementations, the described approach can be integrated with GITHUB and any CI/CD pipeline to ensure scopes for all dependencies are correct and minimal.

### Reduce Deployment Times and Bandwidth Usage.

For deployments, artifacts/binaries need to be rolled-out to servers or clients. Smaller artifacts/binaries mean faster deployment and less bandwidth used. Use of the described approach will enable faster and cheaper rollouts of artifacts/binaries.

### Reduce Danger of Using the Incorrect Code.

In many situations, parts of software are only provided at runtime. One example for JAVA is database drivers, which are usually provided at runtime. It is common practice to test database operations in a test phase with a different database than one used in production. Too wide of a scope (e.g., “compile” instead of “test”) for a test database driver has the potential to break a production database driver in several ways. For example, outdated drivers with security vulnerabilities or incompatibilities can be provided. Other examples that are problematic with using incorrect code can include logging, web servers, and all kinds of dependencies where it makes sense to substitute production code with test doubles. The described approach has an advantage in potentially preventing difficult to find/fix bugs in a simple and automatic manner.

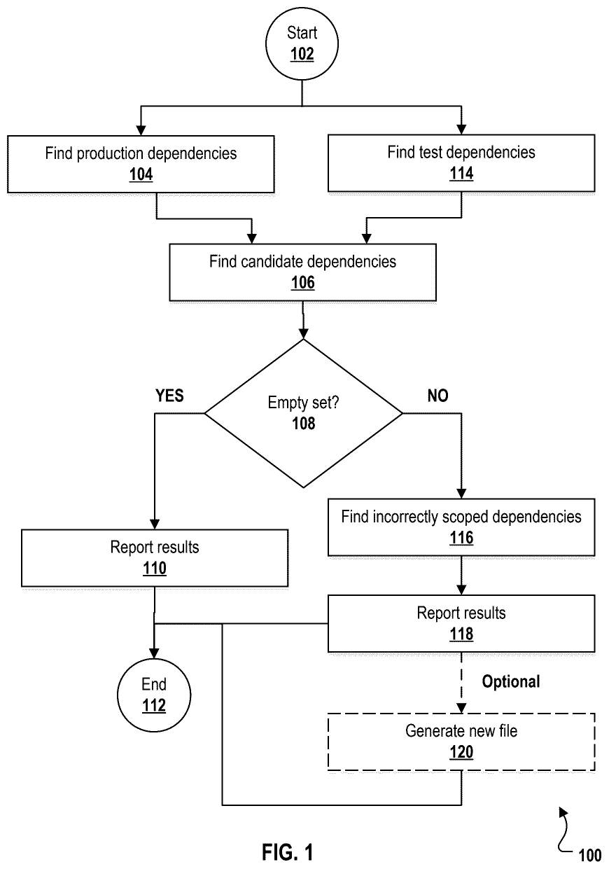

Turning to FIG. 1, FIG. 1 is a flowchart illustrating an example of a method 100 for automatic detection and repair of incorrect scopes in dependencies, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

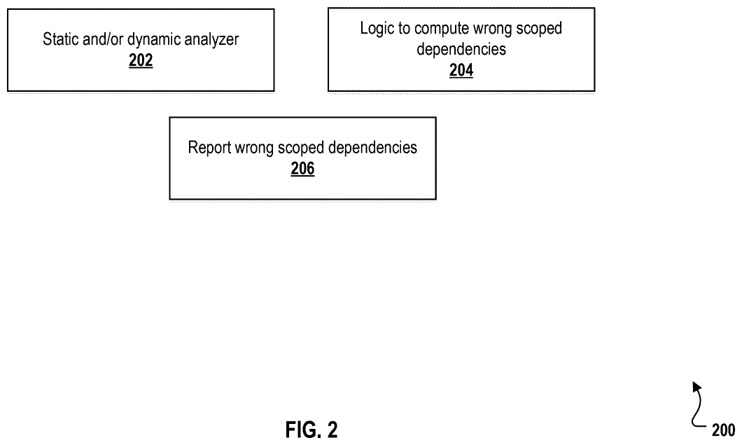

FIG. 2 is a box diagram of a high-level architecture 200 of a system to automatically detect and repair incorrect scopes in dependencies, according to an implementation of the present disclosure.

The described approach utilizes static and/or dynamic analyzers 202 for reachability analysis of software to find the set of dependencies which are only reachable from testing entry points. Logic to compute incorrectly scoped dependencies 204 processes every element of the set of dependencies which has a scope “compile” instead of “test” and builds a set of incorrectly scoped dependencies. Note that the same principle can be utilized to find dependencies with incorrect scope with respect to scopes of “runtime,” “provided,” etc. The set of incorrectly scoped dependencies can then be reported by, for example, a reporting module, in any appropriate format consistent with this disclosure (e.g., visual diagram, text, animation, or flow chart).

Returning to FIG. 1, at a lower level, given software S, which has a set of direct/transitive dependencies D, where {d∈D|d is a dependency with any scope of S}, the described approach finds a set of direct/transitive dependencies DWS, where {dws∈DWS|dws is a dependency with a incorrect scope of S}. DWS⊆D must hold true.

In some implementations, steps to find the set DWS, where each dws∈DWS has an incorrect scope “compile” instead of a “test” scope, includes:

At 102, method 100 starts. From 102, method 100 can proceed to either a 104 (production) path or 114 (test) path, and, in some implementations, will perform both paths. In the example implementation of FIG. 1, method 100 will perform both paths, but proceeds first to the 104 (production).

At 104, given a set of entry points (production) EPP for software S, which are used in production (e.g., a main method, public application programming interface (API) for libraries, and start script for scripting languages), perform a static and/or dynamic reachability analysis to find the set reachable dependencies in production {drp∈DRP| of drp is a dependency of S reachable in production}. From 104, method 100 proceeds to 106.

At 106, find a set of candidate dependencies DC, where {dc∈DC|dc∉DRP∧dc∈DRT}. When DC=Ø, stop because DWS⊆DC=Ø. From 106, method 100 proceeds to 108.

At 108, a determination is made as to whether an empty set exists. If it is determined that an empty set exists, method 100 proceeds to 110. Otherwise, if it is determined that an empty set does not exist, method 100 proceeds to 116. Here, it is determined that an empty set exists, and method 100 proceeds to 110.

At 110, results are reported. From 110, method 100 proceeds to 112.

At 112, method 100 can end (for the applicable path being run—i.e., production or test).

In the example implementation, method 100, since running both paths, would then return to the 114 (test) path. At 114, given a set of entry points (test), EPT for the software S which are used for testing the software S (e.g., test classes/methods/public programming interfaces which are utilized/exercised by a test runner (i.e., a program which discovers, executes, and reports on tests). Perform a static and/or dynamic reachability analysis to find the set of reachable dependencies in testing {drt∈DRT|drt is a dependency of S reachable during testing}. From 114, method 100 proceeds to 106 and to 108 as described above. Alternatively, at 108, a determination is made that an empty set does not exist. From 108, method 100 proceeds to 116.

At 116, a set of incorrectly scoped dependencies DWS if found, where {dws|dws has scope “compile” instead of “test”}. Meaning: 1) iterate over all candidate dependencies DC and a check performed for the scope “compile” instead of “test” and 2) that the scope is incorrect is known, because analysis has proven that it is not possible to reach code provided by the dependency from any scope but “test.” From 116, method 100 proceeds to 118.

At 118, once a set of incorrectly scoped dependencies DWS is found, DWS can be reported. From 118, method 100 can proceed to 112, as previously described, or (optionally) 120.

At 120, a new file is generated. That is, the information of DWS can be used to automatically rewrite the information/file of the direct/transitive dependencies D, which is used by a build tool/dependency manager, which would automatically fix the incorrect dependencies. Another approach could be to use the set DWS to generate a new version of the file/information with fixed scopes for all dependencies automatically, which is used by the build tool/dependency manager, so that the fixed scopes can be tested easily and used for future builds. From 120, method 100 can proceed to 112, as previously described.

As an illustrative example, how to identify two dependencies with too wide a scope in a JAVA software project is demonstrated. Given a JAVA project with the following set of direct (dependencies, scope):
{(org.junit.jupiter:junit-jupiter, ‘test’), (org.apache.logging.log4j:log4j-api, ‘compile’), (org.apache.logging.log4j:log4j-core, ‘compile’)}.
   and two source code files:

```
1. The application source code HelloWorld.java:
package sap;
public class Hello World {
  public static void main(String... args) {
    System.out.println(″Hello, world!″);
  }
}.
2. The testing source code TestHelloWorld:
package sap;
import org.apache.logging.log4j.LogManager;
import org.apache.logging.log4j.Logger;
import org.junit.jupiter.api.Test;
import static org.junit.jupiter.api.Assertions.assertTrue;
public class TestHello World {
  @Test
  void canary( ) {
    assertTrue(true);
  }
  @Test
  void loggingAsASideEffect( ) {
    final Logger logger = LogManager.getLogger(HelloWorld.class);
    logger.fatal(″This is a non-fatal logger fatal message.″);
    assertTrue(true);
  }
}.
```

When the described approach is applied and a static analysis of the byte code utilizing a library like JDEPENDENCY is utilized:

The set of direct software dependencies is:
{(org.junit.jupiter:junit-jupiter, ‘test’), (org.apache.logging.log4j:log4j-api, ‘compile’), (org.apache.logging.log4j:log4j-core, ‘compile’)}.

The set of direct software dependencies reachable from HelloWorld.java is the empty set, because HelloWorld.java does not use/refer to any of our direct dependencies:
{ }.

The set of direct test dependencies reachable from TestHelloWorld is:
{(org.junit.jupiter:junit-jupiter, ‘test’), (org.apache.logging.log4j:log4j-api, ‘compile’), (org.apache.logging.log4j:log4j-core, ‘compile’)}.

The set of dependencies with an incorrect scope is the set of all test dependencies which are not in the (in this example empty) set of software dependencies and have the scope compile:
{(org.apache.logging.log4j:log4j-api, ‘compile’), (org.apache.logging.log4j:log4j-core, ‘compile’)},
   which is a result of applying the described approach and could be fixed automatically and/or reported to a user/build system.

A proof of concept implementing a plugin for the APACHE MAVEN build and utilizing a static analysis approach utilizing the library JDEPENDENCY can either be executed without installation from a command line for an APACHE MAVEN project, or added to a projects POM.XML file as a plugin that will always be executed during a “verify” phase.

For the previously provided JAVA example, a sample invocation from a command line interface (CLI) could be:
mvn com.sap: dependency-bleed-plugin: 1.0.0-SNAPSHOT: report
The plugin would then generate the following report in the file ‘./target/dependency-bleed-report.md”:
Dependencies with scope ‘compile’ which should have scope ‘test’:
   org.apache.logging.log4j:log4j-api:jar:2.23.1:compile
   org.apache.logging.log4j:log4j-core:jar:2.23.1:compile.
      If a dependency from DC has the scope “compile” it will end up in the artifact/deliverable although it is only used/needed during the testing phase of the software.

The described approach could be enhanced in different ways. For example, failing the APACHE MAVEN build if an incorrectly scoped dependency is detected and generating a new POM.XML (i.e., POM.XML is an XML file which declares dependencies and build directives which are utilized by the APACHE MAVEN build tool) file with correct scopes for all dependencies. To illustrate this point, for example an entry for the org.apache.logging.log4j:log4j-core dependency looks like this in the POM.XML file (note, if no scope is given, APACHE MAVEN assumes ‘compile’ as default scope:

<dependency>
<groupId>org.apache.logging.log4j</groupId>
<artifactId>log4j-core</artifactId>
<version>2.23.1</version>
</dependency>.

To fix this entry in the POM.XML file, one can simply add the scope attribute with a value of ‘test’ either directly inside the POM.XML file or in a newly create FIXED-POM.XML file:

<dependency>
<groupId>org.apache.logging.log4j</groupId>
<artifactId>log4j-core</artifactId>
<version>2.23.1</version>
<scope>test</scope>
</dependency>

A “fail the build flag” can also be leveraged to permit use of the described approach in CI/CD pipelines. The plugin for the APACHE MAVEN can be executed using a Maven build utility. It is a standard practice, that such a plugin has an option to fail a build, when a wrongly scoped dependency is detected. CI/CD pipelines utilize a project specific build system (like Maven) to automatically build an artifact the CI/CD pipeline is supposed to build. Therefore, for every build system which has a plugin similar to the described example plugin, one or more wrongly scoped dependencies could automatically fail a build in a CI/CD environment or even just for local builds.

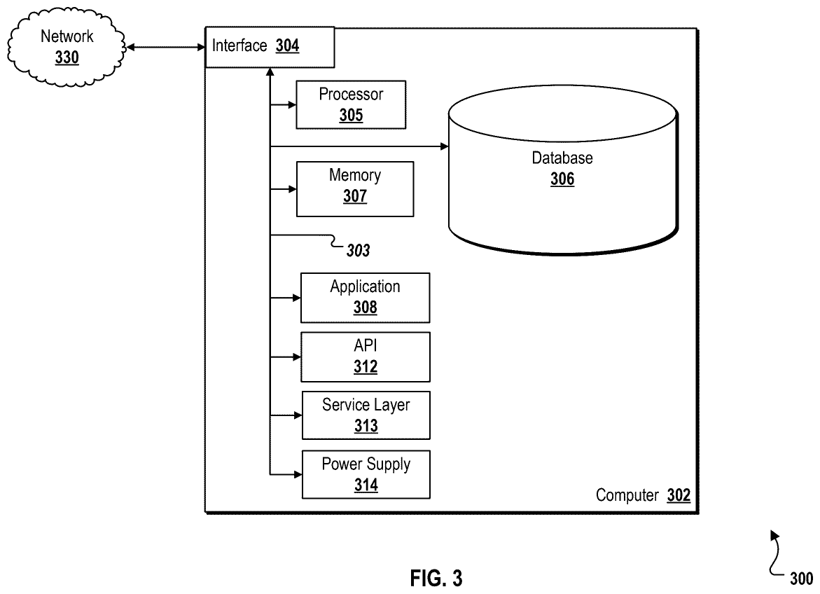

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, computer-implemented system 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any, or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302. The Database 306 can hold and operate on at least any data type mentioned or any data type consistent with this disclosure.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

Described implementations of the subject matter can include one or more features, alone or in combination.

For example, in a first implementation, a computer-implemented method, comprising: finding, using a plugin, a set of reachable dependencies in a production environment; finding, using the plugin, a set of reachable dependencies in a test environment; finding, using the plugin, a set of candidate dependencies; determining, using the plugin, that an empty set does not exist; finding, using the plugin and as incorrect dependencies, a set of incorrectly scoped dependencies; and reporting the incorrect dependencies.

The foregoing and other described implementations can each, optionally, include one or more of the following features:

A first feature, combinable with any of the following features, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

A second feature, combinable with any of the previous or following features, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

A third feature, combinable with any of the previous or following features, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

A fourth feature, combinable with any of the previous or following features, wherein: for the set of candidate dependencies DC, {dc∈DC|dc∉DRP∧dc∈DRT}; and when DC=Ø, stop, because DWS⊆DC=Ø.

A fifth feature, combinable with any of the previous or following features, wherein, finding, using the plugin and as incorrect dependencies, a set of incorrectly scoped dependencies, comprises: iterating over all candidate dependencies; and performing a check for a particular scope, wherein that the particular scope is incorrect is known.

A sixth feature, combinable with any of the previous or following features, comprising, generating a new file to correct the incorrect dependencies.

In a second implementation, a non-transitory, computer-readable medium storing one or more instructions executable by a computer system to perform one or more operations, comprising: finding, using a plugin, a set of reachable dependencies in a production environment; finding, using the plugin, a set of reachable dependencies in a test environment; finding, using the plugin, a set of candidate dependencies; determining, using the plugin, that an empty set does not exist; finding, using the plugin and as incorrect dependencies, a set of incorrectly scoped dependencies; and reporting the incorrect dependencies.

The foregoing and other described implementations can each, optionally, include one or more of the following features:

A first feature, combinable with any of the following features, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

A second feature, combinable with any of the previous or following features, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

A third feature, combinable with any of the previous or following features, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

A fourth feature, combinable with any of the previous or following features, wherein: for the set of candidate dependencies DC, {dc∈DC|dc∉DRP∧dc∈DRT}; and when DC=Ø, stop, because DWS⊆DC=Ø.

A fifth feature, combinable with any of the previous or following features, wherein, finding, using the plugin and as incorrect dependencies, a set of incorrectly scoped dependencies, comprises: iterating over all candidate dependencies; and performing a check for a particular scope, wherein that the particular scope is incorrect is known.

A sixth feature, combinable with any of the previous or following features, comprising, generating a new file to correct the incorrect dependencies.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: finding, using a plugin, a set of reachable dependencies in a production environment; finding, using the plugin, a set of reachable dependencies in a test environment; finding, using the plugin, a set of candidate dependencies; determining, using the plugin, that an empty set does not exist; finding, using the plugin and as incorrect dependencies, a set of incorrectly scoped dependencies; and reporting the incorrect dependencies.

The foregoing and other described implementations can each, optionally, include one or more of the following features:

A first feature, combinable with any of the following features, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

A second feature, combinable with any of the previous or following features, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

A third feature, combinable with any of the previous or following features, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

A fourth feature, combinable with any of the previous or following features, wherein: for the set of candidate dependencies DC, {dc∈DC|dc∉DRP∧dc∈DRT}; and when DC=Ø, stop, because DWS⊆DC=Ø.

A fifth feature, combinable with any of the previous or following features, wherein, finding, using the plugin and as incorrect dependencies, a set of incorrectly scoped dependencies, comprises: iterating over all candidate dependencies; and performing a check for a particular scope, wherein that the particular scope is incorrect is known.

A sixth feature, combinable with any of the previous or following features, comprising, generating a new file to correct the incorrect dependencies.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
finding, using a plugin, a set of reachable dependencies in a production environment;
finding, using the plugin, a set of reachable dependencies in a test environment;
finding, using the plugin, a set of candidate dependencies;
determining, using the plugin, that an empty set does not exist;
finding, using the plugin and as incorrect dependencies, a set of incorrectly scoped dependencies; and
reporting the incorrect dependencies.

2. The computer-implemented method of claim 1, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

3. The computer-implemented method of claim 2, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

4. The computer-implemented method of claim 3, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

5. The computer-implemented method of claim 4, wherein:
for the set of candidate dependencies DC, {dc∈DC|dc∉DRP∧dc∈DRT}; and
when DC=Ø, stop, because DWS⊆DC=Ø.

6. The computer-implemented method of claim 4, wherein, finding, using the plugin and as incorrect dependencies, a set of incorrectly scoped dependencies, comprises:
iterating over all candidate dependencies; and
performing a check for a particular scope, wherein that the particular scope is incorrect is known.

7. The computer-implemented method of claim 1, comprising, generating a new file to correct the incorrect dependencies.

8. A non-transitory, computer-readable medium storing one or more instructions executable by a computer system to perform one or more operations, comprising:
finding, using a plugin, a set of reachable dependencies in a production environment;
finding, using the plugin, a set of reachable dependencies in a test environment;
finding, using the plugin, a set of candidate dependencies;
determining, using the plugin, that an empty set does not exist;
finding, using the plugin and as incorrect dependencies, a set of incorrectly scoped dependencies; and
reporting the incorrect dependencies.

9. The non-transitory, computer-readable medium of claim 8, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

10. The non-transitory, computer-readable medium of claim 9, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

11. The non-transitory, computer-readable medium of claim 10, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

12. The non-transitory, computer-readable medium of claim 11, wherein:
for the set of candidate dependencies DC, {dc∈DC|dc∉DRP∧dc∈DRT}; and
when DC=Ø, stop, because DWS⊆DC=Ø.

13. The non-transitory, computer-readable medium of claim 11, wherein, finding, using the plugin and as incorrect dependencies, a set of incorrectly scoped dependencies, comprises:
iterating over all candidate dependencies; and
performing a check for a particular scope, wherein that the particular scope is incorrect is known.

14. The non-transitory, computer-readable medium of claim 8, comprising, generating a new file to correct the incorrect dependencies.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
finding, using a plugin, a set of reachable dependencies in a production environment;
finding, using the plugin, a set of reachable dependencies in a test environment;
finding, using the plugin, a set of candidate dependencies;
determining, using the plugin, that an empty set does not exist;
finding, using the plugin and as incorrect dependencies, a set of incorrectly scoped dependencies; and
reporting the incorrect dependencies.

16. The computer-implemented system of claim 15, comprising, for software S with a set of direct/transitive dependencies D, wherein {d∈D|d is a dependency with any scope of S}, finding a set of direct/transitive dependencies DWS, wherein {dws∈DWS|dws is a dependency with an incorrect scope of S}, and wherein DWS⊆D is true.

17. The computer-implemented system of claim 16, wherein, given a set of entry points (production) EPP for the software S, finding, using a plugin, a set of reachable dependencies in a production environment {drp∈DRP|drp is a dependency of S reachable in production} comprises performing a static or dynamic reachability analysis.

18. The computer-implemented system of claim 17, wherein, given a set of entry points (test) EPT for the software S, finding, using the plugin, a set of reachable dependencies in a test environment {drt∈DRT|drt is a dependency of S reachable during test} comprises performing a static or dynamic reachability analysis.

19. The computer-implemented system of claim 18, wherein:
for the set of candidate dependencies DC, {dc∈DC|dc∉DRP∧dc∈DRT}; and
when DC=Ø, stop, because DWS⊆DC=Ø.

20. The computer-implemented system of claim 18, wherein, finding, using the plugin and as incorrect dependencies, a set of incorrectly scoped dependencies, comprises:
iterating over all candidate dependencies; and
performing a check for a particular scope, wherein that the particular scope is incorrect is known.
